(19) United States
(12) Patent Application Publication
(10) Pub. No.: US 2002/0159614 A1
(43) Pub. Date: Oct. 31, 2002

(54) Message coding for digital watermark applications

(76) Inventors: Brett Alan Bradley, Portland, OR (US); Hugh L. Brunk, Portland, OR (US)

Correspondence Address: DIGIMARC CORPORATION, 19801 SW 72ND AVENUE, SUITE 100, TUALATIN, OR, 97062, US

(21) Appl. No.: 10/020,519

(22) Filed: Dec. 14, 2001

Related U.S. Application Data
(60) Provisional application No. 60/256,627, filed on Dec. 18, 2000.

(51) Int. Cl. G06K 9/00

(52) U.S. Cl. 382/100

(57) ABSTRACT

This disclosure describes methods for coding messages for digital watermark applications. One method combines the use of different error correction coding schemes to error correction encode an auxiliary message, and then imperceptibly embeds that coded message into a media signal, such as an image, video or audio signal. A particular example of this method is a concatenated code where the auxiliary message is encoded using convolution coding and Reed Solomon coding before being embedded in a host media signal in a digital watermarking process. Another method combines M-ary signaling with error correction coding to encode the auxiliary message, and then imperceptibly embeds the resulting message signal into a host media signal. One specific example is illustrated where a watermark embedder applies Reed Solomon coding to an auxiliary message, and then M-ary modulates the resulting Reed Solomon coded message. The watermark embedder then embeds the M-ary modulated message into a host media signal. Another example employs convolution coding and then M-ary modulation.

### RELATED APPLICATION DATA

This patent application claims the benefit of U.S. Provisional patent application Ser. No. 60/256,627 filed Dec. 18, 2000, which is hereby incorporated by reference.

### TECHNICAL FIELD

The invention relates to steganography, digital watermarking and data hiding.

### BACKGROUND AND SUMMARY

Digital watermarking is a process for modifying physical or electronic media to embed a machine-readable code into the media. The media may be modified such that the embedded code is imperceptible or nearly imperceptible to the user, yet may be detected through an automated detection process. Most commonly, digital watermarking is applied to media signals such as images, audio signals, and video signals. However, it may also be applied to other types of media objects, including documents (e.g., through line, word or character shifting), software, multi-dimensional graphics models, and surface textures of objects.

Digital watermarking systems typically have two primary components: an encoder that embeds the watermark in a host media signal, and a decoder that detects and reads the embedded watermark from a signal suspected of containing a watermark (a suspect signal). The encoder embeds a watermark by altering the host media signal. The reading component analyzes a suspect signal to detect whether a watermark is present. In applications where the watermark encodes information, the reader extracts this information from the detected watermark.

Several particular watermarking techniques have been developed. The reader is presumed to be familiar with the literature in this field. Particular techniques for embedding and detecting imperceptible watermarks in media signals are detailed in the assignee's co-pending application Ser. No. 09/503,881 and U.S. Pat. Nos. 5,862,260 and 6,122,403, which are hereby incorporated by reference.

This disclosure describes improved methods for coding messages for digital watermark applications. One method combines the use of different error correction coding schemes to error correction encode an auxiliary message, and then imperceptibly embeds that coded message into a media signal, such as an image, video or audio signal. A particular example of this method is a concatenated code where the auxiliary message is encoded using convolution coding and Reed Solomon coding before being embedded in a host media signal in a digital watermarking process.

Another method combines M-ary signaling with error correction coding to encode the auxiliary message, and then imperceptibly embeds the resulting message signal into a host media signal. One specific example is illustrated where a watermark embedder applies Reed Solomon coding to an auxiliary message, and then M-ary modulates the resulting Reed Solomon coded message. The watermark embedder then embeds the M-ary modulated message into a host media signal. Another example employs convolution coding and then M-ary modulation.

### BRIEF DESCRIPTION OF DRAWINGS

FIG. 1 illustrates a digital watermark detection process for a watermarked image signal.

FIG. 2 illustrates a process of M-ary symbol detection.

FIG. 3A illustrates a plot of bit error rate in testing of various message coding schemes for digital watermarking.

FIG. 3B illustrates a plot of payload error rate in testing of various message coding schemes for digital watermarking.

### DETAILED DESCRIPTION

The disclosure describes compatible watermark decoding methods for each of the encoding methods outlined above. While the disclosure specifically uses examples of still image watermarking, the message coding schemes apply to watermarking of other media types as well, such as audio signals.

Introduction

In image digital watermarking, a variety of factors can make it very difficult to recover the watermark message. Clearly, one such factor is that the watermark message power must be much less than that of the host image in order to maintain the original image fidelity. Another factor is that the watermarked image is likely to undergo a series of degradations: lossy compression, analog conversion (e.g., printing) and digital recapture, and filtering are some examples. A third problem is that, in some watermarking schemes, the watermark message shares the channel with a synchronization signal, which may inherently interfere with it. Finally, some applications demand that we are able to recover the watermark message from a very small image, or a very small sub-section of the original image. These factors also apply to digital watermarking of video and audio as well.

In some applications of digital watermarking, the objective is to embed N bits in a digital image that can later be recovered after various image degradations. In this paper we explore possibilities for the encoding of data that will be subject to the effects of the watermark channel. The channel, which is inextricably connected to our choice of a variant on spatial spread spectrum watermarking schemes, is very often characterized by extremely low signal to noise ratios (SNR). In order to get even a modest number of bits as throughput, one is forced to resort to somewhat complicated methods of data embedding. We begin the paper by drawing a distinction between the watermark signal domain, and the raw watermark bit domain in an example image watermarking scheme. The two are related through a variant of classic direct sequence spread spectrum communications, and we will use this relationship to develop the parameters for possible error correction schemes. We will also address uncoded biorthogonal M-ary modulation and determine whether or not it is a viable alternative to traditional error correction coding techniques in the context of watermarking.

The Watermark Signal Domain and its Relationship to Direct Sequence Spread Spectrum

Embedder

The watermark embedder used in our testing is based on Direct Sequence Spread Spectrum. An example of such an embedder is described in A. Alattar, “Smart Images”, Proceedings of SPIE Vol. 3971, pp. 264-273, San Jose, 2000. In this embedder, a pseudo random binary key of length J is used to represent each bit. In other words, one watermark bit maps to J watermark chips. Depending upon the sign of the bit, the watermark key or its inverse is used. Each of the J components of the key is associated with a physical pixel location in the N×M image. The process is analogous to direct sequence spread spectrum communications in that a single bit is mapped to a chipping sequence of length J. We will concern ourselves with the transition from the watermark pixel domain (chips) to the Raw Bit watermark domain where we can apply error correction. The characteristics of the transition process are important because they dictate what is possible in the raw domain.

Model for Noise in the Watermark Pixel Domain

We begin our analysis by composing a model that describes how the watermark reader sees the watermarking channel. We concentrate on the process of watermark chip extraction and bit recovery. Suppose that we are given, an area of N×M pixels in the watermark domain. i.e. we have synchronized to the watermark coordinate system. The total received signal at each pixel location, denoted by parameters i and k, can be described by the following equation:

rᵢ^{(k)}=wᵢ^{(k)}+Iᵢ^{k}+gᵢ^{k}+nᵢ^{k}, (1)

where I is the host image, w is the watermark message, g is the synchronization signal, and n is additional noise due to the “channel.” The variables i and k denote that the pixel location in question is associated with the k^{th} chip of watermark bit i. In general there are N total bits in the watermarked image, and there are J chips that belong to each bit. The total noise power at each pixel, which includes everything but the watermark itself, is typically enormous compared with the watermark chip power.

Correlation Receiver

The successful retrieval of a watermark bit depends upon the noise present at each of the watermark chips. In classic direct sequence spread spectrum communications the relationship between chips and bits is defined in terms of signal to noise ratio and processing gain. The signal to noise ratio at the chip level is SNR₀ and the corresponding probability of error is

Q({square root over (SNR₀))} (2)

if one is to attempt to determine the polarity of one of the chips. In such classic direct sequence spread spectrum systems, the noise at the chip level is typically close to white Gaussian, and therefore it behooves us not to make hard decisions at the chip level in order to determine the value of a particular bit. Rather, all chips are taken into account together by using a linear correlation receiver. In white Gaussian noise, such a receiver is optimum. The parameters of the receiver are described as follows: if Kᵢ is the chipping sequence of length J that is used to represent the i^{th} bit, then the received signal, Rᵢ for that bit can be described by

Rᵢ=bᵢKᵢ+Nᵢ (3)

Rᵢ in equation (3) is really just the vector form of equation (1). The watermark vector is now represented by bᵢKᵢ and all noise components including the image and synchronization signal have been collapsed into the noise vector Nᵢ. The linear correlation receiver performs the inner product between the received signal, Rᵢ, and the chipping sequence Kᵢ. This procedure results in the detection statistic

sᵢ=Jbᵢ+φ, (4)

where the scalar value, ø=<Kᵢ, Nᵢ>, represents the output noise of the correlator. The estimated value of the bit, bᵢ, is obtained by taking the polarity of sᵢ. The estimated polarity of a bit, after linear correlation, is much more reliable than the estimated polarity of an individual chip. The net effect of the linear correlation process is that the signal to noise ratio is increased by a factor equal to the number of chips per bit (SNR₀−>J*SNR₀). The factor J, which corresponds to the number of chips, is called the processing gain. The probability of error is decreased from that at the chip level by substituting the new SNR into (2). Note: if the bit is of a particular type of error correction bits, we do not make hard decisions on the detector statistic. Rather, the decoding process uses the magnitude of the resulting information to make better decisions downstream.

A Receiver with Pre-filtering

Due to the host of factors listed in the introduction, straightforward application of the linear correlation receiver simply will not suffice. The probability of error is substantial enough for a watermark bit that the payload is unrecoverable even when using error correction coding. In order to mitigate the problem, a filter that takes advantage of local image pixel correlation is applied to the neighborhood of each of the chips belonging to the bit we are interested in receiving. By filtering the chips prior to applying the linear correlation receiver, the probability of error is reduced significantly. We use a filter that has a simple response for all input values within the range of interest; i.e. any local neighborhood of pixels. In our notation Nₓ is an arbitrary neighborhood of image pixels centered on pixel x, F( ) denotes the filter, and Rᵢ′ is the filtered version of Rᵢ, which is defined in equation (3).

F(Nₓ)∈{−1,0,1} (5)

R′ᵢ=F(N_{R}_{ᵢ}) (6)

The filter makes hard decisions about the polarity of the message at the chip level taking into account each chip pixel's neighborhood. We could just as well call this a binary symmetric channel with error probability, p, and nonzero erasure probability. For the present, we will ignore erasures reintroducing the state at a later time for completeness. By dropping the zero state of the output of the tri-level watermark pixel domain filter, its response to the neighborhood can be described by the binary set of outputs {−1,1}. Given that our watermark message at the chip level is a binary antipodal signal, the probability of successfully recovering the message chip polarity is described by a Bernoulli random variable. After extracting the chip, the correlation receiver is used to obtain a soft estimate of the corresponding bit.

Due to the type of noise present at each watermark pixel, and the type of receiver filter used, we do not benefit from the same amount of processing gain that conventional spread spectrum systems obtain. Because we make hard decisions at the pixel or chip level prior to using the correlation receiver, we suffer an approximate 2 dB penalty compared with the correlation receiver in white gaussian noise (The watermark together with image and other noise is decidedly NOT described by a Gaussian white channel, and therefore the 2 dB loss does not apply. Rather, we have found that we benefit substantially in most situations when such a filter is used). After application of the linear correlation receiver, the probability of error in the Raw Bit watermark domain is described by a distribution that is the sum of J Bernoulli random variables. If the Bernoulli probability is the same for all chips that comprise the bit of interest, a Binomial random variable will describe the probability of error. Specifically, we will have a watermark bit error when less than J/2 of the filtered chips agree with their corresponding key entries.

$${P}_{err} = {\sum }_{k = 0}^{J / 2} \frac{N !}{k ! ( N - k ) !} {{p}^{k} ( 1 - p )}^{N - k} \qquad ( 7 )$$

In truth, the Bernoulli probability, p, varies with each chip's position, and hence the above equation only roughly describes the situation. If we define the mean Bernoulli probability for the chips, pₘₑₐₙ, then the probability of error in (7) is pessimistically described by pₘₑₐₙ replacing p. The reason is that the mean of the bit estimate will be the same, but the variance will be smaller than that of the Binomial distribution when p varies across the watermarked media.

The characteristics of the chip filter lend itself to easy analysis at later stages. By specifying a range of Bernoulli probabilities for making a chip error and including the dimensions of the total watermarked area in terms of pixels, we can calculate the net probability of error for the entire system (spread spectrum through error correction). However, we will find it even more convenient to break things down at a level beyond that of the chip. We will refer to this level as the Raw Bit domain.

The Raw Bit Domain

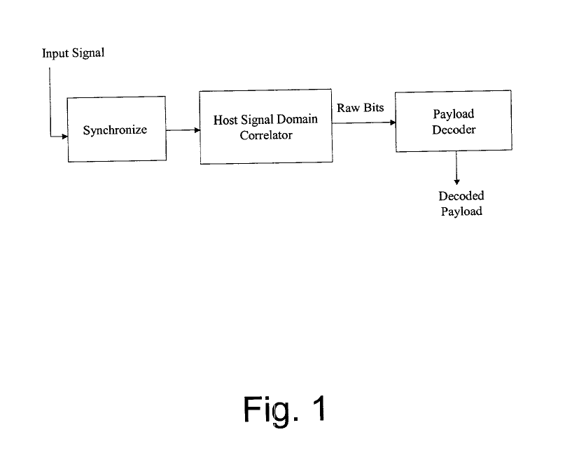

We introduce an intermediate domain that lies between the watermark reader, and the final decoded payload bits called the Raw Bit domain. The relationship between the Raw Bit domain, and the other domains mentioned is shown in FIG. 1. First, the watermark reader synchronizes the watermark signal embedded in the input signal using a technique such as described in U.S. Pat. Nos. 5,862,260 and 6,122,403. It then filters the input signal and correlates the filtered signal with the key to generate estimates of raw bits (error correction encoded bits). Finally, the reader decodes the error correction encoded bits in the payload decoder.

FIG. 1 encapsulates all error correction coding methods that we will consider; it will need to be adjusted for M-ary modulation. In the Raw Bit domain, a bit is composed of J chips. As we shall see, the conversion to Raw Bits allows us to express our channel as a white Gaussian noise channel governed by input SNR instead of by Bernoulli probabilities. The importance of the conversion is that the gains from various coding schemes are easily determined when the Raw Bits are subject to white Gaussian noise. For large enough J, the modified binomial distribution, which describes our bit error statistic, approximates a Gaussian distribution with mean and variance described by the equations below.

μ=2Jp−J (8)

σ²=4Jp(1−p) (9)

We define the signal to noise ratio as

$$SNR = \frac{{μ}^{2}}{{σ}^{2}} = \frac{{J ( p - \frac{1}{2} )}^{2}}{p ( 1 - p )} \qquad ( 10 )$$

The mean and variance are different than those of a normal Binomial distribution because the Bernoulli alphabet we use is {−1, 1} instead of {0,1}. The SNR is proportional to J, which makes it very easy to make simple adjustments to the SNR when J is changed. For the case of chips described by Bernoulli random variables with varying p, the resultant bit error probability is not Binomial, but it too is approximately Gaussian for large enough J. In this case, the resulting SNR will be slightly better than equation (10).

Another reason it is a good idea to define things at the Raw Bit level is that any change in the local filter applied before correlating with the key would change the behavior and probability of error at the pixel level, but in the Raw Bit domain the statistics would remain approximately Gaussian. The net change at the Raw Bit level would be a shift in SNR, which would not require any sort of re-analysis. Generally, error corrected bits will consist of a different number of chips than J. We can accommodate such cases by adjusting the signal to noise ratio appropriately. This can be done very easily because, as described above, the processing gain (SNR) is very simply related to the number of chips used in the bit. The overall system works as follows. Given the performance of the watermark reader at the pixel level we can define a range of Bernoulli parameters, pₘₑₐₙ, for the gamut of watermarking channel conditions within interest. We can then translate this number to a signal to noise ratio at the Raw Bit level, and see what the probability of error for the candidate error correction scheme is operating at that level of SNR and define our probability of error for a given decoding scheme. Again, for each pₘₑₐₙ within the range of interest, the corresponding SNR is a lower bound.

At this time we reintroduce our watermark chip filter as a binary symmetric channel with nonzero erasure probability. Erasures will reduce the number of watermark chips in a Raw Bit by an amount proportional to the erasure probability. If the erasure probability is pₑ then the number of chips, J, per Raw Bit will be reduced, on average, to J(1−pₑ). The net effect is a decrease in SNR in the raw domain—typically a marginal one because pₑ is small. Since we have converted all components of the watermark domain into a Raw Bit domain representation, we will drop our treatment of the former in what follows.

Error Correction Codes and M-ary Modulation

Convolutional Codes and Reed-Solomon Codes

Suppose we have a payload of L bits that we would like to embed in an image. Error correcting codes increase the payload size by adding redundant information. It is the redundant information that allows the code to do its job, to correct errors. In watermarking the cost associated with increasing the payload size is that there will be a smaller SNR per coded bit. Error correcting codes are useful if and only if the coding gain achieved by introducing redundancy more than makes up for the loss in SNR. The amount of redundant information, and hence the expansion in payload size, is expressed by the code's rate. For every k bits of uncoded data, n bits are embedded in the watermarked media. The code's rate is defined as R=k/n.

Error correction decoders operate upon the Raw Bit values (output of the correlator defined above.) Each of the Raw Bits takes on a number from −J to J, where J is the length of the chipping sequence. Some decoders make hard binary decisions on each of the Raw Bits where the sign of the value is the basis for the decision. The decoder then decodes actual payload bits on the resulting sequence. Generally speaking, there is some loss of information in making hard decisions on the Raw Bits prior to decoding. It is possible to implement decoders that operate on the Raw Bits themselves. Such decoders, termed soft decoders, typically perform better than their counterparts—hard decoders. However, in most cases, the extra computational cost of soft decoding is prohibitive. As examples, we illustrate two distinct classes of error correction codes, Reed-Solomon block codes and Convolutional codes.

Reed-Solomon codes are a particular type of block code. A typical (n,k) block coder maps blocks of k bits into blocks of n coded bits. The coder is said to be memory-less because the n coded bits depend only on the k source bits. Hard decoding is almost always used in practice with block codes, and in such cases the block decoder will correct up to t bit errors. Reed-Solomon codes can be thought of as a generalization of block codes where symbols, instead of bits, make up block elements. In other words, the coder maps blocks of k symbols into blocks of n coded symbols. Each of the n coded symbols is taken from an alphabet of 2^{m} orthogonal symbols. For most cases that we will consider symbols correspond to groups of bits; for example, L bits will be represented by k symbols composed of n bits each. One reason Reed Solomon codes are often used in practice is because they have good minimum distance properties. The minimum distance, dₘᵢₙ=n−k+1, is directly related to the code's capacity to correct symbol errors. The code is guaranteed to correct up to t=½(dₘᵢₙ+1) symbol errors. Another reason these codes are often used is that efficient hard-decoding algorithms are available.

Convolutional codes are used more often than block codes because they are conceptually and practically simpler to implement, and their performance is often superior. Convolutional codes have memory; passing an L bit information sequence through a linear shift register generates encoded data. The input bits are shifted into the register, k bits at a time, and n coded bits are output to produce the n/k increase in redundancy. The maximum delay (memory) of the shift register, and hence the code, is called the constraint length. The fact that convolutional codes are linear codes with memory makes them suitable for efficient soft decoding algorithms, e.g. the Viterbi algorithm.

One peculiar thing about convolutional codes, in particular, when they are used for short payload lengths, is their behavior in terms of the total decode at both low and high SNR. The success of the total decode is a much more important quantity to monitor than the bit error rate. For watermarking applications, we typically will accept the result of the decode only when that result is error free. Any number of bit errors is too many. For the un-coded case, the probability of correct payload retrieval is directly related to the probability of a bit error. For example, we know that in un-coded signaling the probability of no bit errors (complete message retrieval) is (1−p_{b})^{N}, where N is the number of bits. However, for convolutional codes, the probability of a bit error does not tie in neatly to the probability of correctly decoding. At low SNR the probability of a bit error will be high, but the probability of decoding the payload correctly will be much higher than one might expect. Errors are not independent; they almost always occur in groups. Another curious behavior occurs at high SNR. To see this, consider a Viterbi decoder operating on the k^{th} bit of a payload of arbitrary length. The coded version of the k^{th} bit is represented by r encoded bits beginning at index r(k−1)+1 of the coded sequence. It is well known that a final decision on any given payload bit should be made much later than the above correspondence would indicate. Specifically, if the group of r coded bits beginning at index r(k−1)+1 is the latest to enter the decoder, then decisions on the k−jD^{th} payload bit will be near optimal, where D is the constraint length of the code and j is an integer—typically j equal to 4 or 5 will suffice. In terms of decoding a watermark message at high SNR, the probability of a bit error should be very low. However, because we have a small payload, decisions regarding the final bits in the payload must be made prematurely, effectively increasing the error probability. Decisions are made prematurely because there is no decoding delay available.

Concatenated Codes

In some applications convolutional codes are combined with Reed Solomon codes to form what is called a concatenated code. A Reed-Solomon encoder is used on the payload bit string; it is referred to as the outer code. The Reed-Solomon encoded data is then itself encoded using a convolutional code; the inner code. The method has been used for deep space communications (definitely a low SNR environment!). The idea is to exploit the strengths and cater to the weaknesses of each type of code. Reed-Solomon codes offer performance superior to that of convolutional codes, but only for reasonably good channels. For very poor channels convolutional codes work better. Using the convolutional code to “clean up” the raw channel allows the Reed-Solomon code to work where it can perform its best. Another synergy between the two codes is that the convolutional decoder tends to produce bursty errors, which is what the Reed-Solomon code is best at correcting.

3.3 M-ary Methods

In his paper, M. Kutter introduced a signaling scheme for watermarking that was a generalization of binary signaling at the bit level. See M. Kutter, “Performance Improvements of Spread Spectrum Based Image Watermarking Schemes Through M-ary Modulation”, Preliminary Proceeding of the Third International Information Hiding Workshop, pp. 245-260, Dresden, 1999. This scheme, called biorthogonal M-ary signaling, maps groups of log2(M) bits to one of M symbols. The benefit of doing so is that under certain conditions the probability of symbol error becomes arbitrarily small as M goes to infinity. Specifically, if the energy per bit is greater than −1.6 dB, the Shannon limit, the above statement holds. The larger the value of M the fewer symbols we are required to hide in an image to convey the same number of bits. The fewer symbols we have to hide in an image, the more locations we can use per symbol. In other words, the symbol energy increases for increasing M (Although the energy per bit must remain fixed).

We will find it useful to relate the net symbol SNR to Raw Bit SNR, developed earlier. One repetition of a symbol requires M/2 chips or watermark pixel locations. Just as there are many chips per watermark bit in the binary case, each symbol is typically repeated many times in the watermark domain to increase its aggregate SNR. We will use an example to ease the process of development. Suppose we have an L×L pixel area to be watermarked; call this the “TotalPixelArea.” Further suppose that we would like to embed N bits. In the binary case it is easy to see that each bit will get (TotalPixelArea/N) chip repetitions. The SNR per bit is related to the Raw Bit SNR by a multiplication factor,

SNR_{b}=aSNR_{raw}, (11)

where a=(TotalPixelArea/N)/J. For example, if TotalPixelArea=128×128, N=64 bits, and J=32, then a=8, a shift of +9 dB. The more general case is described by the equations below.

$$a = \frac{TotalPixelArea}{\frac{M}{2} ( \frac{N}{log 2 ( M )} ) J} \qquad ( 12 )$$

In equation (12), M/2 is the number of pixels required per symbol repetition, N/log2(M) is the total number of symbols needed to represent the required number of embedded bits, and J is the number of pixels (chips) per Raw Bit.

$${SNR}_{Symb} = {aSNR}_{Raw} \frac{M}{2} \qquad ( 13 )$$

Results using the above equations are tabulated for some sample parameters, below.

TABLE 1
N = 60-64bits, rawbitSnr = −2 dB, chips/rawBit = 32,
Symbol Size = M/2

| M | Num Symbols | Symbol Reps | Symbol SNR(dB) |
|---|---|---|---|
| 2 | 64 | 256 | 7 |
| 8 | 21 | 195 | 11 |
| 16 | 16 | 128 | 13 |
| 32 | 12 | 85 | 14 |
| 64 | 10 | 51 | 15 |

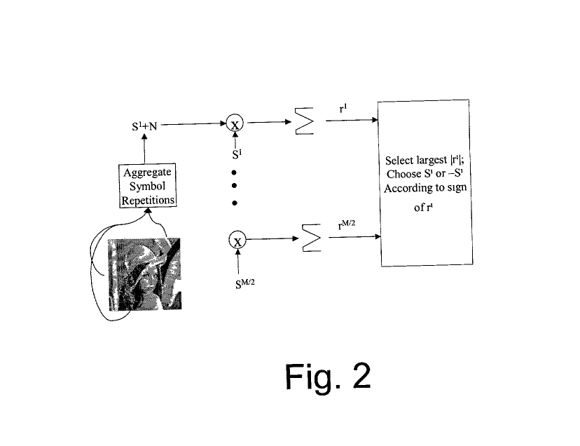

Here we summarize the process of embedding and detecting M-ary symbols. M distinct signals are produced by computing an M/2 order Hadamard matrix, H_{M/2}. To generate the additional M/2 biorthogonal entries, we append the sign-reversed version of H_{M/2} to itself. The detection process works by garnering all available symbol repetitions from the watermark pixel domain to form an aggregate noisy estimate of the symbol, Sⁱ+N. We would use, for example, the same chip filtered described by equations (5, 6) to prefilter each contribution to a symbol element. M/2 correlators of length M/2 are used in the detection process, which is described and shown in FIG. 2.

The “SymbolSNR” is the SNR of each symbol element prior to match filtering with the bank of M/2 correlation receivers, R=S+N and sᵢ²/var(Nᵢ). Selecting the symbol is a two-step process: It requires largest magnitude determination followed by sign determination.

Making an error at the symbol level can be accomplished by confusing the correct symbol with its antipodal version, or mistaking one of the other possible M/2 symbols for the correct one. Errors almost always occur due to the second condition mentioned because the distance in signal space between orthogonal signals is half that of antipodal signal^{1,5}. The probability of error for biorthogonal M-ary signals, p_{M}, is given in Proakis' book as a function of symbol signal to noise ration, SNR_{S}. We reproduce the equation here.

$${P}_{M} = 1 - \frac{1}{\sqrt{2 π}} {\int }_{- \sqrt{2 {SNR}_{S}}}^{∞} {( \frac{1}{\sqrt{2 π}} {\int }_{- ( v + \sqrt{2 {SNR}_{S}} )}^{v + \sqrt{2 {SNR}_{S}}} {e}^{- {x}^{2} / 2} ⅆ x )}^{M / 2 - 1} {e}^{- {v}^{2} / 2} ⅆ v \qquad ( 14 )$$

The equation may be evaluated numerically for different values of M and SNR_{S}. We are more interested in the probability of not decoding the entire watermark, p_{W}. Every symbol is represented independently in the image and each has the same SNR_{S} (the reason for equal SNR_{S} is a result of an interleaving procedure²). We require the successful demodulation of all symbols that make up the bit payload to be successful. The equation governing our success is

P_{W}=1−(1−P_{M})^{N/log}^{₂}^{(M)} (15)

Combining M-ary Signaling with Error-correction Coding

So far we have treated error correction coding and M-ary modulation as if they are mutually exclusive methods. We now consider message coding for digital watermarks employing M-ary modulation with error correction. We consider two examples of hybrid M-ary and error correction techniques.

Reed Solomon codes are particularly suited to M-ary modulation when the full alphabet of 2^{k} symbols is used. To embed L bits with standard M-ary modulation would require K, M-ary symbols, where Klog2(M) is equal to L. Using Reed Solomon codes, the K, M-ary symbols are converted to a larger number, N, for embedding. Since more symbols are required to embed the same number of bits, the SNR per symbol will decrease. The probability of symbol error at the output of the decoder is upper-bounded by

$${P}_{es} = \frac{1}{N} {\sum }_{i = t + 1}^{N} i ( N , i ) {{P}_{M}^{i} ( 1 - {P}_{M} )}^{N - i} \qquad ( 16 )$$

where P_{M} is given in equation (14), but the quantity must be adjusted for the loss in SNR.

SNRdB−>SNRdB−10log10(N/K) (17)

The probability of decoding the payload is given by (15). As we shall see, at low SNR the un-coded case is superior. The situation is reversed for higher SNR.

In limited bandwidth situations, trellis coding is often used to enhance performance. Trellis coding consists of first convolutionally encoding the information bits, and then using line coding to select a symbol to transmit from the available constellation. For example, in digital communications, one might use a rate ⅓ convolutional code, and then map the triplet of bits to a symbol in an 8-PSK constellation. On the decoding side, a Viterbi soft decoder would map the symbols to received bits. The symmetry in the constellation makes for a large minimum distance error event, and hence the gain over an un-coded system is substantial.

It is possible to construct a quasi-trellis coding scheme using convolutional codes and M-ary modulation. In the M-ary orthogonal scheme, however, all symbol errors barring the antipodal symbol are equally likely, and therefore the minimum distance error event will be closer than in a more conventional trellis-coding scheme. Nevertheless, let us proceed with an illustration of such a scheme. Suppose we apply 8-ary modulation to rate ⅓ convolutionally encoded bits. Coded bits, in groups of three, are mapped to a unique symbol. The detector will perform M-ary detection as normal using the bank of correlation receivers. Instead of selecting the symbol where the correlation is maximum and making hard decisions on the coded bits, the decoder will use the strength of that correlation value with reference to the next highest in order to assign a soft reliability metric to the chosen symbol. The resulting soft values are fed to a Viterbi soft decoder.

Error Correction Coding and Uncoded M-ary Simulation Results

In the discussion that follows, the word “protocol” is synonymous with a data-encoding scheme. In fact, it supersedes it since M-ary modulation is not truly an error-correction encoding scheme. Table 2 shows a listing of the various protocols that have been considered in this study. Protocols with convolutional codes, Reed-Solomon codes, and also concatenated Reed-Solomon and convolutional codes have been examined. In addition, we simulated several different levels of M-ary signaling. For the concatenated codes, an effort was made to look at a variety of code rate allocations between the Reed-Solomon and convolutional code. For all types of protocols, the number of chips, or equivalently Raw Bits, per protocol bit was also varied to identify the best compromise between coding and repetition. In all protocols the total number of chips used is 128×128. All convolutional codes used were memory 8 codes (with 128 states), except a single protocol where a memory 7 code was used to see if it paradoxically could perform better due to the small decoding trellis. Most protocols were designed to allow approximately 64 bits for the digital watermark message payload; small deviations sometimes had to be made to accommodate the available Reed-Solomon codes, and various M-ary levels.

Refer to FIG. 1. It shows a diagram of the reader broken into three components: synchronization, watermark reading, and payload decoding. The only input to the payload-decoding block is the sequence of raw values, one for each bit or symbol of the protocol. The factor that determines the performance of the payload-decoding block is the statistical relationship between the original protocol bits and the Raw Bits that are input to the decoding block. We have chosen a range of SNR that truly stresses the various methods considered.

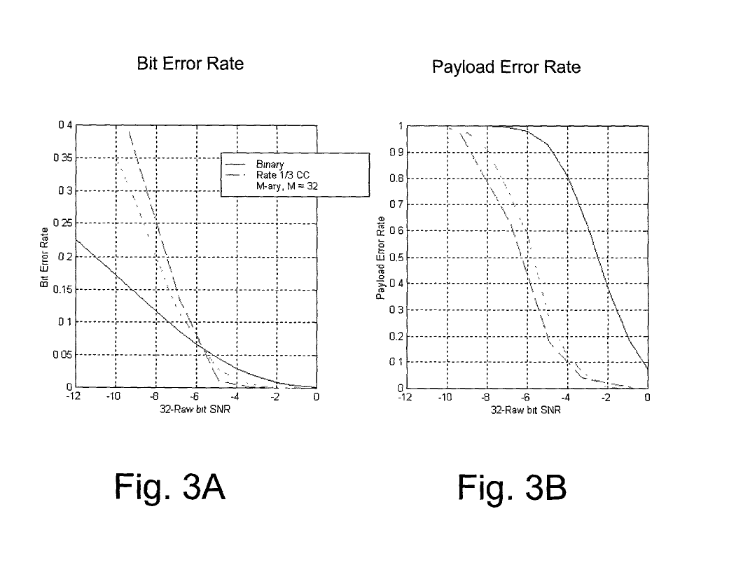

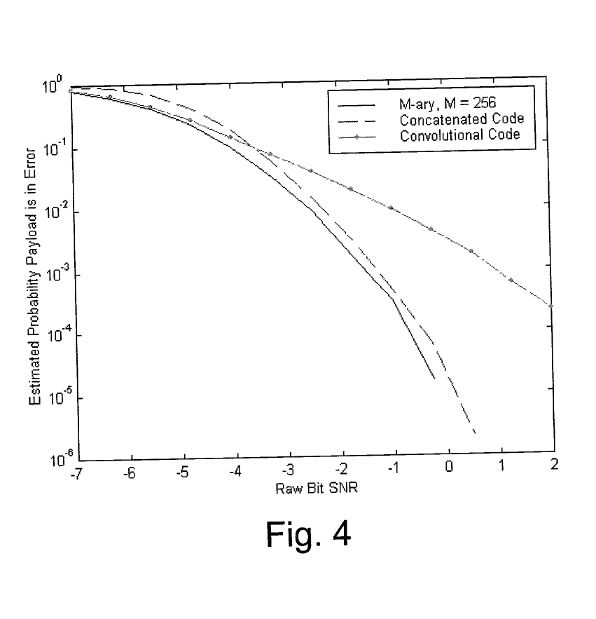

Before going into detail regarding simulation results, we perform a cursory comparison with expected theoretical results involving the bit error rate, which is a conventional measure of reliability in digital communications, and point out a few problems with relying entirely on the measurement. FIGS. 3A and 3B show the bit error rate and payload error rate for three message coding schemes. In this example, the payload is 56 bits, and three different message coding methods are compared: binary modulation, 32-ary biorthogonal modulation, and binary modulation with rate ⅓ convolutional codes employing soft Viterbi decoding. The three methods are compared over the same range of Raw Bit SNR, where a Raw Bit is comprised of 32 chips. For binary modulation, the actual SNR per bit is the Raw Bit SNR+9.47 dB due to the extra space available per bit for processing gain. The rate ⅓ convolution coding method gets half that, an additional 4.5 db of processing gain per coded bit; the other 4.5 dB was used for coding gain. The SNR per bit of the M-ary scheme is essentially the same as that for the binary scheme, but the SNR per symbol is log2 (M) greater.

Comparing the binary method with that using convolutional codes in FIG. 3A, we see that the former has a lower bit error rate until −6 dB, after which it is supplanted by the coding scheme. The M-ary symbol error rate is higher than the binary bit error rate until −4 dB. The M-ary bit error rate is always lower than its symbol error rate, since each symbol consists of a group of bits. It is approximated by ½ the symbol error rate for large M.

Viewing FIG. 3B, which depicts the probability of a correct decode for each of the methods, we notice that for low Raw Bit SNR the probability of error for the binary scheme is enormous. For the range of SNR where it appeared better than the as convolutional coding technique in terms of bit error rate, the method is essentially useless if there is no tolerance for bit errors—a stipulation that seems reasonable when the payload is small.

More interesting, and less obvious, is that the probability of a payload error for the convolutional coding method is always less than that of the binary method, even in the region where bit error probability would suggest otherwise. In fact the probability of a decode error is arguably reasonable, for some applications, when the bit error rate is still marginally high. For example at −6 dB the bit error rate is roughly 0.1 and the corresponding probability of decoding the entire payload correctly is as high as 0.6. The reason for this phenomenon is that, using our example, 60% of the noisy payload data will succeed in being decoded as a whole. The other 40% will be characterized, in general, by bursts of errors. This all or nothing result is a consequence of considering the data in one lumped sum. A conclusion that can be drawn from this is that bit error rate is not a very interesting statistic when applied to convolutional coding of small payloads. Another observation about convolutional codes is that the probability of error for high SNR is worse than experienced with such a technique would indicate. The reason for this is that Viterbi soft decoders need a delay of about 4-5 times the constraint length prior to making bit decisions in order to operate at their optimum rate. We, however, are forced to make immediate decisions for data at the tail of the bit stream because of the very small payload size, a fact that significantly increases the probability of error.

The performance of each of the protocols was simulated for SNR ranging from −7 dB to −2 dB in steps of 1 dB. The SNR is given in terms of a Raw Bit with 32 chips; for simulation purposes the SNR was adjusted as appropriate for other number of chips/bit. Each data point was obtained from simulating 8000 randomly chosen payloads and passing them through the AWGN channel. For reasons mentioned in the preceding paragraphs, we quote the performance of the total decode and ignore the bit error rate. Results showing the probability of correct payload decoding are shown in Table 3.

A few very general remarks can be made concerning the various classes of protocols. Protocols employing pure Reed-Solomon block codes did not perform well over the chosen range of SNR. Our result is consistent with that posted by others who have tried BCH codes, a binary block code. The two protocols that used pure convolutional codes of differing rates performed well, better than those that used Reed-Solomon codes for all SNR in the simulation. Several of the concatenated codes achieved very good rates of decoding the payload correctly at high SNR. The higher order M-ary schemes did reasonably well at all SNR, and they were among the best at higher SNR in particular.

Protocols that use convolutional codes as their primary ingredient are not a bad choice for watermarking. Comparing Protocols 29 and 30, the two that used convolutional codes of rates ⅓ and ¼ respectively, we can say that the overall performance is about the same. The higher rate (⅓) is slightly better at low SNR, but at a higher and more useable SNR, the rate ¼ code might be marginally superior. Protocols 11, 12, and 14-16 used concatenated codes and they performed at least as well as Protocols 29 and 30 at high SNR. The reason for this is that at approximately −4 dB we begin to see a transition, whereas the error characteristics of protocols 29 and 30 change from error patterns characterized by bursts that plague the entire payload to shorter error events at the tail of a payload. The short error events, which are a result of early trellis truncation in the Viterbi Algorithm, are corrected if an outer code is used, provided we can accommodate the loss in SNR required by the extra coding. In light of this discussion, one might argue that a concatenated code operating upon the entire payload is overkill. If instead of using a traditional concatenated code, we apply a BCH code to the tail of a convolutionally encoded payload we would protect the most error prone part of the payload. The impact in terms of SNR would be less than that of the concatenated code because we would be required to embed fewer coded bits.

Protocols that use pure M-ary modulation, with large M, are also a reasonable choice for watermarking under the simulated conditions. Protocol 36, which has M=256, is arguably the best of all protocols for the simulated range of SNR. It is, of course, possible to consider values of M larger than 256 if processing time is of a lesser concern. The computational complexity analysis below shows that Protocol 36 requires almost 5 times the number of operations that Protocol 29 does. However, a Fast Walsh Transform can significantly curtail the number of required operations. The Fast Walsh Transform is possible when a Walsh-Haddamard set of basis functions is used—the case we simulated here.

Having identified some promising protocols, further simulation was performed. Protocols #11, #30, and #36 were simulated over a range from −10 dB to −1 dB in steps of 0.75 dB. Each data point is the result of 500000 simulation trials. In FIG. 4, we plot the estimated probability of not correctly decoding the payload in its entirety. Comparing Protocols #11 and #30, the two based on error-correction schemes, we see that which of the two protocols is best depends on the SNR. For poor effective channels, the protocol with a convolutional code outperforms the protocol with a concatenated code. For better channels the situation is reversed. Protocol #36, which is an M-ary method, performs better than the two error-correction coding techniques, throughout the simulated range of SNR. We conclude that M-ary modulation is certainly a suitable method for watermarking.

Complexity Analysis

In this section, we address issues of computational complexity for each method.

1. Convolutional Coding using the Viterbi Algorithm—complexity increases linearly with payload size. Refer to references J. G. Proakis, “Digital Communications,” 3^{rd} Edition, Chapters 5, 8, McGraw-Hill, 1995. and E. A. Lee, D. G. Messerschmitt, “Digital Communications,” 2^{nd} Edition, Chapters 9, 13, 14, Kluwer Academic Publishers, MA, 1994 for more information. K is the constraint length and L is the introduced coding redundancy. The following is for rate 1/L convolutional codes.

2^{L} Euclidean distance calculations per payload bit.

3L operations per Euclidean distance calculation. 3L or 3L −1 (L adds+L mults+L−1 adds).

2×2^{k} adds per payload bit.

2^{k} Compares per payload bit.

NumOps=N×(2^{L}×3L+2×2^{k}+2^{k})

Example: Protocol number 29 has N=64, L=3, and K=8. The number of operations is on the order of 54000.

2. Reed Solomon Codes-

Varies greatly depending upon algorithm used. In general, the complexity is less than that of convolutional codes.

3. M-ary Signaling-

M/2 adds plus M/2 multiplies per correlation with 1 of M/2 symbols.

M/2 symbols to be correlated against.

M/2+1 operations to determine the embedded symbol after correlation (choose the symbol based on the sign of the maximum correlation magnitude).

N/log2(M) symbols required.

NumOps_{Mary}=N/log2(M)*(M×M/2+M/2+1)

Example: Protocol number 36 has M=256, and N=64. The number of operations required is on the order of 263,000, almost 5 times that of the Convolutional code example.

Concluding Remarks

The class of digital image watermarking techniques based on spread spectrum methodology is often characterized by very low SNR. Methods have been proposed that either enhance the basic technique by applying error correction codes, or generalize the spread spectrum principle using M-ary modulation to obtain better results. Comparisons between different error correction schemes have been made previously, but this paper expands on the theme by testing multiple code rates, exploring parameter allocation, and introducing concatenated codes. Furthermore, M-ary schemes are compared against the various error correction coding methods. In the context of our comparison, we have chosen to introduce a framework called the Raw Bit domain that allows us to distill down the elements of competing schemes so that we can make direct comparisons given channel conditions (SNR), and payload size.

As a result of our simulations, we believe that convolutional codes alone or concatenated with Reed-Solomon codes can be a good choice to increase payload robustness. M-ary methods, for M greater than or equal to 256, are at least as good of a choice, considerations of computational complexity aside. Soft Convolutional decoding techniques suffer a bit more than one would expect at high SNR when the payload is small, a fact that makes them inferior to higher order M-ary techniques. Some types of concatenated codes are able to mitigate this problem at high enough SNR. In watermarking, the channel noise characteristics are likely to vary substantially, a fact that should be kept in mind when choosing a coding scheme.

TABLE 2a
Protocol Descriptions and Parameters (Error Correction
Coding)

| | # | #chips/ | | | | | |
|---|---|---|---|---|---|---|---|
| Protocol | Payload | protocol | RS | RS | RS | CC | CC |
| # | Bits | bits | symbol | N | K | rate | memory |
| 1 | 60 | 32 | 6 | 42 | 10 | 0.5 | 8 |
| 2 | 63 | 32 | 7 | 36 | 9 | 0.5 | 8 |
| 3 | 60 | 32 | 6 | 28 | 10 | 0.33 | 8 |
| 4 | 63 | 32 | 7 | 24 | 9 | 0.33 | 8 |
| 5 | 60 | 32 | 5 | 25 | 12 | 0.25 | 8 |
| 6 | 60 | 32 | 6 | 21 | 10 | 0.25 | 8 |
| 7 | 63 | 32 | 7 | 19 | 9 | 0.25 | 8 |
| 8 | 60 | 64 | 5 | 25 | 12 | 0.5 | 8 |
| 9 | 60 | 64 | 6 | 21 | 10 | 0.5 | 8 |
| 10 | 63 | 64 | 7 | 18 | 9 | 0.5 | 8 |
| 11 | 60 | 64 | 5 | 17 | 12 | 0.33 | 8 |
| 12 | 60 | 64 | 6 | 14 | 10 | 0.33 | 8 |
| 13 | 63 | 64 | 7 | 12 | 0 | 0.33 | 8 |
| 14 | 60 | 96 | 5 | 17 | 12 | 0.5 | 8 |
| 15 | 60 | 96 | 6 | 14 | 10 | 0.5 | 8 |
| 16 | 63 | 96 | 7 | 12 | 9 | 0.5 | 8 |
| 17 | 63 | 32 | 7 | 73 | 9 | — | — |
| 18 | 64 | 32 | 8 | 64 | 8 | — | — |
| 19 | 60 | 64 | 6 | 42 | 10 | — | — |
| 20 | 63 | 64 | 7 | 36 | 9 | — | — |
| 21 | 64 | 64 | 8 | 32 | 8 | — | — |
| 22 | 60 | 96 | 6 | 28 | 10 | — | — |
| 23 | 63 | 96 | 7 | 24 | 9 | — | — |
| 24 | 64 | 96 | 8 | 21 | 8 | — | — |
| 25 | 60 | 128 | 5 | 25 | 12 | — | — |
| 26 | 60 | 128 | 6 | 21 | 10 | — | — |
| 27 | 63 | 128 | 7 | 18 | 9 | — | — |
| 28 | 64 | 128 | 8 | 16 | 8 | — | — |
| 29 | 64 | 85 | — | — | — | 0.33 | 8 |
| 30 | 64 | 64 | — | — | — | 0.25 | 8 |
| 31 | 60 | 64 | 5 | 17 | 12 | 0.33 | 7 |

TABLE 2b
Protocol Descriptions and Parameters (M-ary)

| Protocol | Number of | M-ary |
|---|---|---|
| # | Bits | Level |
| 32 | 64 | 2 |
| 33 | 64 | 16 |
| 34 | 66 | 64 |
| 35 | 63 | 128 |
| 36 | 64 | 256 |

TABLE 3
Comparative Rates of Correct Payload Decoding

| Protocol | | | | | | |
|---|---|---|---|---|---|---|
| # | −7dB | −6dB | −5dB | −4dB | −3dB | −2dB |
| 1 | 0 | 0 | 0 | 0 | 0 | 0 |
| 2 | 0 | 0 | 0 | 0 | 0 | 0 |
| 3 | 0 | 0 | 0 | .03 | .25 | .74 |
| 4 | 0 | 0 | 0 | .02 | .2 | .67 |
| 5 | 0 | 0 | .04 | .28 | .69 | .95 |
| 6 | 0 | 0 | .04 | .25 | .68 | .95 |
| 7 | 0 | 0 | .03 | .21 | .64 | .94 |
| 8 | 0 | 0 | .01 | .12 | .47 | .85 |
| 9 | 0 | 0 | .01 | .12 | .46 | .86 |
| 10 | 0 | 0 | .01 | .1 | .44 | .84 |
| 11 | .03 | .17 | .5 | .82 | .96 | >.99 |
| 12 | 0 | 0 | .53 | .85 | .98 | >.99 |
| 13 | .02 | .08 | .23 | .37 | .42 | .42 |
| 14 | 0 | .08 | .31 | .66 | .9 | .98 |
| 15 | 0 | .1 | .34 | .71 | .93 | .99 |
| 16 | 0 | 0 | 0 | .66 | .91 | .98 |
| 17 | 0 | 0 | 0 | 0 | 0 | 0 |
| 18 | 0 | 0 | 0 | 0 | 0 | 0 |
| 19 | 0 | 0 | 0 | 0 | 0 | .01 |
| 20 | 0 | 0 | 0 | 0 | 0 | 0 |
| 21 | 0 | 0 | 0 | 0 | 0 | 0 |
| 22 | 0 | 0 | 0 | 0 | .04 | .23 |
| 23 | 0 | 0 | 0 | 0 | 0 | .07 |
| 24 | 0 | 0 | 0 | 0 | 0 | 0 |
| 25 | 0 | 0 | 0 | .06 | .23 | .57 |
| 26 | 0 | 0 | 0 | .02 | .12 | .4 |
| 27 | 0 | 0 | 0 | .01 | .06 | .24 |
| 28 | 0 | 0 | 0 | 0 | 0 | 0 |
| 29 | .17 | .43 | .7 | .87 | .94 | .975 |
| 30 | .16 | .4 | .69 | .86 | .94 | .98 |
| 31 | .03 | .17 | .46 | .8 | .96 | .99 |
| 32 | .001 | .006 | .02 | .07 | .22 | .44 |
| 33 | .07 | .18 | .34 | .62 | .78 | .94 |
| 34 | .1 | .27 | .5 | .74 | .92 | .986 |
| 35 | .16 | .39 | .66 | .88 | .97 | .994 |
| 36 | .21 | .45 | .70 | .92 | .98 | .999 |

Having described and illustrated the principles of the technology with reference to specific implementations in the attached paper and documents incorporated by reference, it will be recognized that the technology can be implemented in many other, different, forms. To provide a comprehensive disclosure without unduly lengthening the specification, applicants incorporate by reference the patents and patent applications referenced above.

The methods, processes, and systems described above may be implemented in hardware, software or a combination of hardware and software. For example, the auxiliary data encoding processes may be implemented in a programmable computer or a special purpose digital circuit. Similarly, auxiliary data decoding may be implemented in software, firmware, hardware, or combinations of software, firmware and hardware. The methods and processes described above may be implemented in programs executed from a system's memory (a computer readable medium, such as an electronic, optical or magnetic storage device). The message coding techniques can be applied to variety of different watermark embedding and reading methods, and to a variety of media types and transform domains within signals of those media types. For example raw bits may be embedded in the spatial, frequency, time or transform domain of a host media signal.

The message coding techniques are sufficiently general that they apply for a variety of digital watermark embedding and reading schemes. The description above specifically uses an example of spread spectrum based digital watermark embedding operations that adjust values of samples in a particular signal domain and detecting operations that use a linear correlator with a key. The message coding methods described in this document are not limited to watermarking techniques that employ linear correlators. In fact, the above example illustrates this point because the detector performs a non-linear local filtering of the received signal to estimate the spread spectrum signal embedded in the received signal. Raw bit estimates are then derived from the spread signal using the linear correlator. As such, the detector need not be a “linear” detector.

Since the above methods relate to message coding techniques that generate the raw bits in the embedder and decode the raw bits in the detector, the specific types of watermark embedding operations performed after the raw bits are generated in the embedder and the detecting operations performed before getting the raw bits in the detector are not necessarily critical to the message coding techniques.

Other forms of embedding and detecting may be used such as subtly modulating statistical features of a host signal so that those features have values corresponding to raw message symbols. Specific examples of signal feature-based watermarking include shifting the value of a feature (signal peaks in time, space or frequency, energy, autocorrelation, power) in a direction corresponding to the value of a raw message symbol to be encoded, or quantizing the value of a feature so that it falls into a quantization bin associated with a raw message symbol to be encoded.

Further, spread spectrum techniques, such as binary or M-ary modulation can be combined with such feature based watermarking schemes by applying this modulation to the raw bits after they are encoded using error correction, such as block codes, convolution codes, turbo codes, etc. After applying such error correction and spread spectrum modulation, the resulting intermediate signal is embedded using feature based watermarking. The detector performs the reverse series of operations: feature based watermark detection to get estimates of the spread spectrum signal, spread spectrum demodulation to get estimates of the raw bits, and error correction decoding to reconstruct the original message payload from the raw bits. The spread spectrum message processing may be M-ary or binary. Alternatively, it may be omitted with some other series of message coding being performed instead such as concatenated codes involving block codes and convolutional codes.

The above discussion refers to convolutional codes. As a potential enhancement for some applications, turbo coding can be used as the convolutional coder in the message coding arrangements described above. A turbo coder includes a combination of two convolution coders. These two coders generate parity symbols from two recursive convolutional coders, each with a plurality of states. In addition to being transmitted un-coded, the original message is input to both coders, but an interleaver permutes the original message before inputing it to the second coder. This permutation allows the combined output of the two coders to provide a stronger code.

The above examples of watermark embedding and detecting refer to a watermark signal domain, such as the spatial pixel domain of an image. The same embedding operations can be applied on discrete samples in other signal domains, depending on the type of signal, and design constraints of the digital watermarking application. For images and video, the watermark domain may correspond to a set of frequency coefficient samples in a frequency domain transform of the host signal, such as a Discrete Cosine, Wavelet, or Fourier transform. Similarly, for audio, the watermark domain may correspond to samples in a transform domain, such as a Wavelet, Discrete Cosine, autocorrelation, time-frequency spectrogram, or Gabor transform domain, to list a few examples.

The particular combinations of elements and features in the above-detailed embodiments are exemplary only; the interchanging and substitution of these teachings with other teachings in this and the incorporated-by-reference patents/applications are also contemplated.

I claim:

1. A method of coding a message for digital watermark embedding of the message into a host media signal comprising:
performing a block coding on a message payload;
performing a convolutional coding on the block coded payload to generate a raw message;
digital watermark embedding the raw message into the host media signal.

2. The method of claim 1 including:
spread spectrum modulating the raw message; and digital watermark embedding the raw message into the host media signal.

3. The method of claim 2 wherein the spread spectrum modulation includes modulating raw message bits output from the convolutional coding with a key.

4. A method of decoding a message for digital watermark reading of the message from a host media signal in which the message is embedded, the method comprising:
detecting an estimate of a raw message carried in a digital watermark in the host media signal;
performing convolutional decoding of the estimate of the raw message; and
performing block decoding of the convolutional decoded message to recover the message.

5. The method of claim 4 including:
spread spectrum demodulating the estimate of the raw message from the host media signal.

6. A computer readable medium on which is stored instructions for performing the method of claim 1.

7. A computer readable medium on which is stored instructions for performing the method of claim 4.

8. A method of coding a message for digital watermark embedding of the message into a host media signal comprising:
performing error correction coding on a message payload;
performing M-ary modulation on the error correction encoded payload to generate a raw message;
digital watermark embedding the raw message into the host media signal.

9. The method of claim 8 wherein the error correction coding comprises convolutional coding.

10. The method of claim 8 wherein the error correction coding comprises block coding.

11. The method of claim 10 wherein the block coding comprises Reed Solomon coding.

12. The method of claim 10 wherein the block coding comprises BCH coding.

13. A method of decoding a message for digital watermark reading of the message from a host media signal in which the message is embedded, the method comprising:
detecting an estimate of a raw message carried in a digital watermark in the host media signal by performing M-ary demodulation;
performing error correction decoding of the estimate of the raw message to recover the message.

14. The method of claim 13 wherein the error correction decoding comprises block decoding.

15. The method of claim 14 wherein the block decoding comprises Reed Solomon decoding.

16. The method of claim 13 wherein the error correction decoding comprises convolutional decoding.

17. A computer readable medium on which is stored instructions for performing the method of claim 8.

18. A computer readable medium on which is stored instructions for performing the method of claim 13.
